(19) United States
(12) Patent Application Publication
(10) Pub. No.: US 2016/0206130 A1
(43) Pub. Date: Jul. 21, 2016

(54) FRUIT SQUEEZER

(71) Applicant: Kabushiki Kaisya Leben Hanbai, Yokohama-shi, Kanagawa (JP)

(72) Inventor: Atsushi TAKABU, Kanagawa (JP)

(73) Assignee: Kabushiki Kaisya Leben Hanbai, Yokohama-shi, Kanagawa (JP)

(21) Appl. No.: 14/397,453

(22) PCT Filed: Jun. 5, 2014
(86) PCT No.: PCT/JP2014/064951

§ 371 Date: Oct. 27, 2014

(30) Foreign Application Priority Data
Dec. 5, 2013 (JP) 2013-006904U

(51) Int. Cl. A47J 19/02

(52) U.S. Cl. CPC A47J 19/022

(57) ABSTRACT

A fruit squeezer, comprising: a squeezing section configured such that a fruit is to be pressed thereagainst; a saucer section; a receiving section configured to receive therein fruit juice squeezed by the squeezing section; and a seed removing section formed into a recessed portion in a center portion of the squeezing section, and configured to catch seeds, the seed removing section comprising: an opening portion; a bottom portion; a peripheral wall portion having a tubular shape and connecting the opening portion and the bottom portion to each other; and a plurality of through-holes formed in the bottom portion or the peripheral wall portion or both of the bottom portion and the peripheral wall portion, wherein the seed removing section has a depth larger than a diameter thereof.

surface of the squeezing section. The squeezing section has a volume corresponding to a pulp portion of one half of a halved large citrus fruit, and outlets are drilled at two opposing positions of a peripheral edge of a bowl wall of the bowl body, and a knob portion is separately provided at another position of the peripheral edge.

### CITATION LIST

### Patent Literature

[PTL 1] Japanese Utility Model Registration No. 3034332

### SUMMARY OF INVENTION

### Technical Problem

However, when squeezing the fruit juice, the above-mentioned fruit squeezer squeezes the fruit juice and seeds by the squeezing section at the same time, and the fruit juice and the seeds are accumulated in the bowl body as they are. Accordingly, an operation of separating the fruit juice and the seeds from each other is required. As a result, the separating operation not only costs time and labor but also requires use of a utensil and hands, and hence is not preferred in hygiene.

### Solution to Problem

In order to solve the above-mentioned problem, according to one embodiment of the present invention, there is provided a fruit squeezer, including: a squeezing section configured such that a fruit is to be pressed thereagainst; a receiving section configured to receive therein fruit juice squeezed by the squeezing section; and a seed removing section formed into a recessed portion in a center portion of the squeezing section, and configured to catch seeds, the seed removing section including: an opening portion; a bottom portion; and a peripheral wall portion having a tubular shape and connecting the opening portion and the bottom portion to each other.

Further, the seed removing section may have a depth larger than a diameter thereof.

Further, the squeezing section may have a substantially conical shape projecting upward, the squeezing section including a plurality of ridge portions formed on an outer peripheral surface of the squeezing section so as to project in a radially outer direction, the receiving section may be formed independently of the squeezing section, and may function as a reservoir including at least a body portion and a bottom surface portion, the fruit squeezer may further include a saucer section formed integrally with the squeezing section so as to extend from a lower edge of the squeezing section in the outer peripheral direction and further extend obliquely upward, the saucer section having at least a through-hole that allows the fruit juice to flow down therethrough, and the seed removing section may have a plurality of through-holes formed therein.

Further, the bottom portion of the seed removing section may be detachably fixed to a lower end of the peripheral wall portion of the seed removing section, and may be formed of a seed removing tool including a cylindrical portion having a tubular shape and a seed removing surface that closes a lower end of the cylindrical portion, and the plurality of through-holes of the seed removing section may be formed in the seed removing surface of the seed removing tool.

Further, the seed removing section may include one or a plurality of plate-like seed removing tools, the bottom portion of the seed removing section may have an opening formed in a center portion thereof, each of the one or the plurality of plate-like seed removing tools may be placed on the bottom portion of the seed removing section in use so as to close the opening, and the plurality of through-holes of the seed removing section may be formed in the each of the one or the plurality of plate-like seed removing tools.

Further, the plurality of through-holes of the seed removing section may each include a substantially elongated elliptical through-hole having a width within a range of from 1 mm to 2 mm and a length within a range of from 2 mm to 4 mm.

Further, a part of the plurality of ridge portions of the squeezing section may be formed into a substantially flat surface at a position above the bottom portion of the seed removing section and below the opening portion of the seed removing section, and the substantially flat surface may have a spine-like protrusion formed thereon.

Further, the body portion of the receiving section may include a hollow tubular body having a diameter within a range of from 60 mm to 80 mm, and the receiving section may include a lip portion serving as an upper end of the body portion thereof, the lip portion having a substantially dish-like shape extending in the outer peripheral direction.

Further, the body portion of the receiving section may include a nonslip portion formed of a plurality of shallow grooves extending longitudinally in an outer peripheral surface of the body portion.

Further, the receiving section may include a pedestal portion extending in an umbrella manner from a lower end of the body portion toward the bottom surface portion in the outer peripheral direction.

### Advantageous Effects of Invention

The fruit squeezer according to one embodiment of the present invention can separate the seeds from the fruit juice and pulp and collect the seeds. The fruit squeezer not only reduces time and labor required for the separating operation, but also has excellent hygiene with no need to use a utensil and hands.

### BRIEF DESCRIPTION OF DRAWINGS

FIG. 1A is a side cross-sectional view of a fruit squeezer according to an example of a first embodiment of the present invention.

FIG. 1B is a side cross-sectional view of a fruit squeezer according to another example of the first embodiment of the present invention.

FIG. 2 is a top plan view of the fruit squeezer according to the first embodiment of the present invention.

FIG. 3 is a perspective view of a fruit squeezer according to a second embodiment of the present invention.

FIG. 4 is a side cross-sectional view of the fruit squeezer according to the second embodiment of the present invention.

FIG. 5 is a perspective view of a fruit squeezer according to Modified Example 1 of the second embodiment of the present invention.

FIG. 6 is a perspective view of a fruit squeezer according to Modified Example 2 of the second embodiment of the present invention.

FIG. 7 is a side cross-sectional view of the fruit squeezer according to Modified Example 2 of the second embodiment of the present invention.

FIG. 8A is a side cross-sectional view of a fruit squeezer according to an example of Modified Example 3 of the second embodiment of the present invention.

FIG. 8B is a side cross-sectional view of a fruit squeezer according to another example of Modified Example 3 of the second embodiment of the present invention.

FIG. 9 is a side cross-sectional view of a fruit squeezer according to Modified Example 4 of the second embodiment of the present invention.

FIG. 10 is a top plan view of an example of a seed removing tool of the fruit squeezer according to Modified Example 4 of the second embodiment of the present invention.

FIG. 11 is a side cross-sectional view of a fruit squeezer according to a third embodiment of the present invention.

FIG. 12 is a side cross-sectional view of a fruit squeezer according to Modified Example 1 of the third embodiment of the present invention.

FIG. 13 is a view illustrating a cut surface of one half of a halved grapefruit.

### DESCRIPTION OF EMBODIMENTS

Now, embodiments of the present invention are described with reference to the drawings. For the sake of convenience, the present invention is described below using a grapefruit as an example, but the present invention is not limited thereto. The present invention is applied to a wide variety of fruits such as a pomelo and a natsumikan (Chinese citron).

### First Embodiment

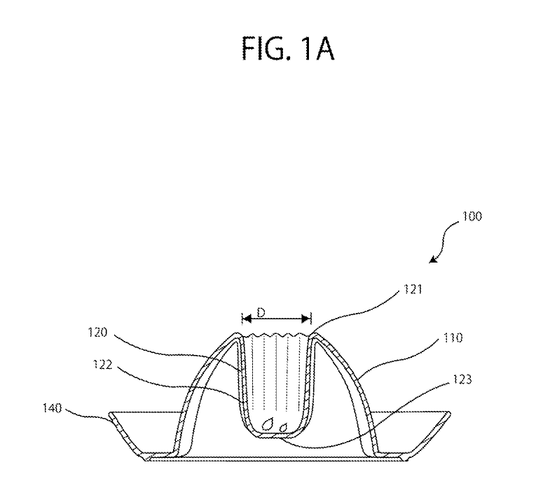

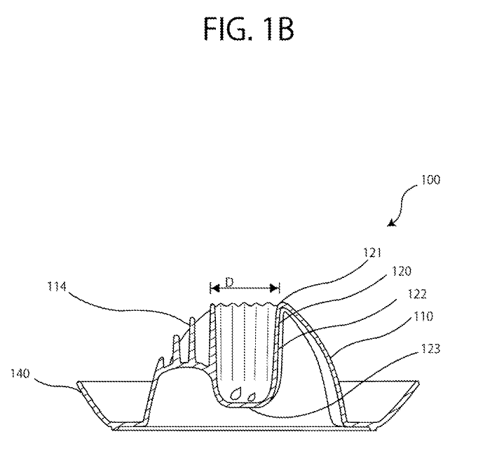

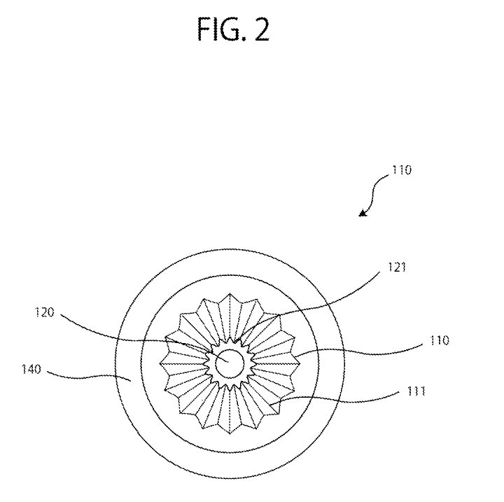

First, a configuration of a fruit squeezer 100 according to a first embodiment of the present invention is described. FIG. 1A is a side cross-sectional view of the fruit squeezer 100. FIG. 2 is a top plan view of the fruit squeezer 100. As illustrated in FIGS. 1A and 2, the fruit squeezer 100 includes a squeezing section 110, a seed removing section 120, and a receiving section 140.

The squeezing section 110 is brought into abutment on a cut surface of one half of a halved grapefruit so as to squeeze fruit juice contained in pulp of the grapefruit. The squeezing section 110 has a substantially conical shape projecting upward, and includes a plurality of ridge portions 111 that are formed on an outer peripheral surface of the squeezing section 110 so as to project in a radially outer direction. A groove is formed between the adjacent ridge portions.

The seed removing section 120 is formed into a recessed portion in a center portion of the squeezing section 110, and is configured to catch seeds squeezed out of the fruit by the squeezing section 110. The seed removing section 120 is formed, for example, by recessing downward the center portion of the squeezing section 110. The seed removing section 120 includes an opening portion 121, a peripheral wall portion 122, and a bottom portion 123. The ridge portions 111 are arranged radially around the opening portion 121 of the seed removing section 120.

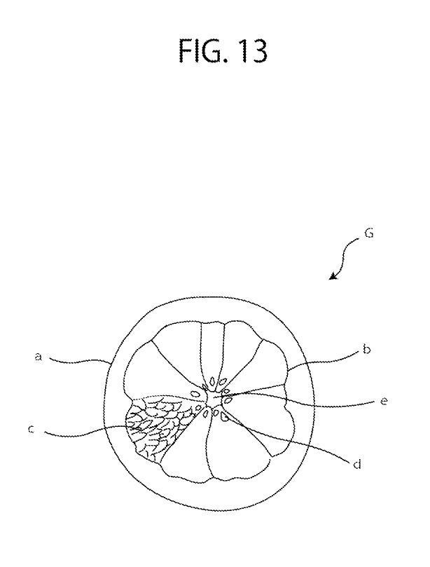

FIG. 13 is a view illustrating a cut surface of one half of a halved grapefruit G. Inside a peel “a” of the grapefruit G, a plurality of segments “b” each containing pulp C therein surround a core “e”, and seeds “d” are distributed on the core side of each of the segments “b”. That is, in the cut surface, the segments “b” are arranged radially around the core “e”, and the seeds “d” gather around the core “e”. In the following description, a region of the grapefruit where the seeds are distributed is referred to as a seed distribution portion.

The seed removing section 120 is formed so as to have a diameter D that is larger than that of the core “e” of the grapefruit and is equal to a diameter of an outer periphery of the seed distribution portion. For example, the diameter D is set within a range of from 35 mm to 45 mm.

Further, for example, mature large seeds and immature small seeds are present in the grapefruit. The immature seeds are present near the core, and the mature large seeds are present in a part slightly distant from the core. In a case of squeezing the fruit juice together with the seeds using the related-art squeezer to make a drink such as a grapefruit sour, the mature large seeds sink, and the immature small seeds float easily. The floating seeds often bring difficulties in drinking the drink. Accordingly, in a case of setting the immature seeds as a main target, the diameter D may be set to 35 mm or less.

Further, the seed removing section 120 separates and squeezes not only the seeds but also a core portion of each segment. Accordingly, the pulp is easily separated, and thus efficient squeezing is possible. In addition, at the time of squeezing, the peel side of the core slightly protrudes, and the protruding portion is positioned above the recess of the seed removing section 120. Accordingly, the protruding portion does not hit against the squeezing section 110 and does not obstruct the squeezing section 110, and hence it is possible to squeeze a fruit without an unnecessary force. Moreover, after the fruit is squeezed completely, an upper portion of the fruit is turned while being shaken, and thus an axis of the core can be removed by the ridge portions 111 protruding at a lip of the opening portion 121.

The receiving section 140 receives therein the fruit juice squeezed by the squeezing section 110. The receiving section 140 is formed integrally with the squeezing section 110, and is formed so as to extend from a lower edge of the squeezing section 110 in the outer peripheral direction and further extend upward.

Next, processes of squeezing the fruit juice using the fruit squeezer 100 are described.

When one half of the halved grapefruit is placed on the squeezing section 110 with the cut surface of the one half of the halved grapefruit facing down, the opening portion 121 of the seed removing section 120 is brought into abutment on an outer periphery of the seed distribution portion from under the seed distribution portion, and the ridge portions 111 arranged radially around the opening portion 121 of the seed removing section 120 are brought into abutment on inner sides of segment membranes. Then, when turning the one half of the halved grapefruit while pressing the grapefruit further downward, the squeezing section 110 increases an abutting area on the one half of the halved grapefruit while biting the one half of the halved grapefruit, to thereby squeeze the fruit juice and the pulp. The squeezed fruit juice and the squeezed pulp are guided along the grooves of the squeezing section, and are accumulated in the receiving section 140. The seeds are blocked by the peripheral wall portion 122 of the seed removing section 120 to fall into the seed removing section 120, and then are pushed into and collected in the seed removing section 120. Further, as described above, the seed distribution portion, that is, the axis of the core falls naturally in the processes of squeezing the fruit juice, or is cut off using a distal end of the squeezing section 110 so as to fall into the seed removing section 120 in such a manner that the one half of the halved grapefruit is inclined when the distal end of the squeezing section 110 reaches the peel.

As described above, the seed removing section 120 is formed in the center portion of the squeezing section 110, and thus the fruit squeezer 100 can separate the seeds from the fruit juice and collect the seeds. This reduces time and labor required for an operation of separating the fruit juice and the seeds from each other. Further, the fruit squeezer does not require use of a utensil and hands, and hence is hygienic. In addition, squeezing can be performed efficiently while separating a vicinity of the core portion.

Further, as illustrated in FIG. 1B, on the squeezing section 110, spine-like (skewer-like) protrusions 114 may be formed at positions above the bottom portion 123 of the seed removing section 120 and below the opening portion 121. When pressing the cut surface of one half of the halved grapefruit against the squeezing section 110 to squeeze the fruit juice and the pulp, the spine-like protrusions 114 cut the segment membranes, and thus the fruit juice can be squeezed efficiently.

### Second Embodiment

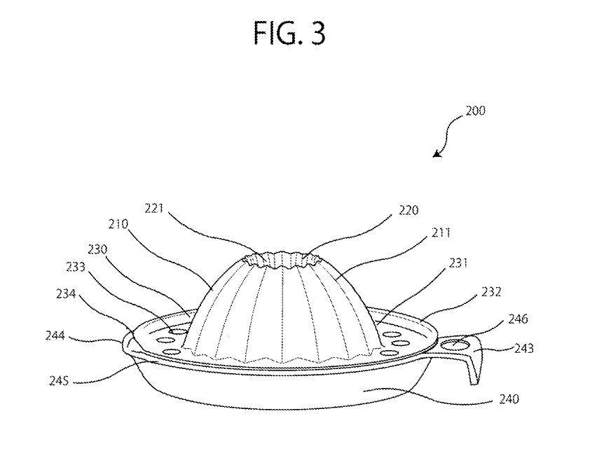

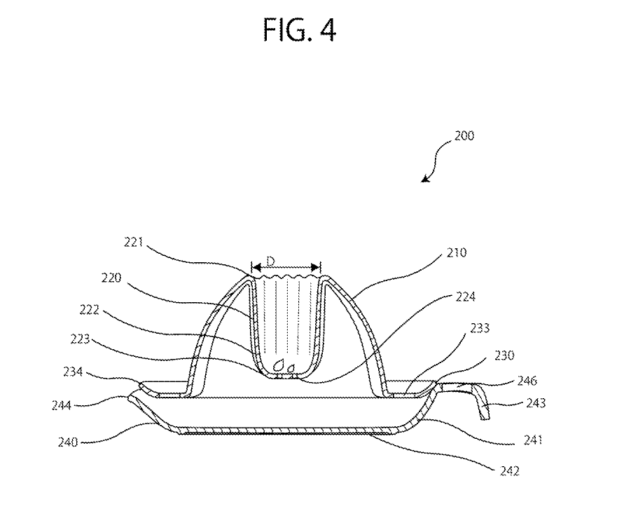

Next, a configuration of a fruit squeezer 200 according to a second embodiment of the present invention is described. FIG. 3 is a perspective view of the fruit squeezer 200, and FIG. 4 is a side cross-sectional view of the fruit squeezer 200. As illustrated in FIGS. 3 and 4, the fruit squeezer 200 includes a squeezing section 210, a seed removing section 220, a saucer section 230, and a receiving section 240.

The squeezing section 210 is brought into abutment on a cut surface of one half of a halved grapefruit so as to squeeze fruit juice and pulp. The squeezing section 210 has a substantially conical shape projecting upward, and includes a plurality of ridge portions 211 that are formed on an outer peripheral surface of the squeezing section 210 to project in a radially outer direction. A groove is formed between the adjacent ridge portions.

The seed removing section 220 is formed into a recessed portion in a center portion of the squeezing section 210, and is configured to catch seeds squeezed out of the fruit by the squeezing section 210. The seed removing section 220 is formed, for example, by recessing downward the center portion of the squeezing section 210. The seed removing section 220 includes an opening portion 221, a peripheral wall portion 222, and a bottom portion 223. The ridge portions 211 are arranged radially around the opening portion 221 of the seed removing section 220.

The seed removing section 220 is formed so as to have a diameter D that is larger than that of the core of the grapefruit and is equal to the diameter of the outer periphery of the seed distribution portion. For example, the diameter D is set within a range of from 35 mm to 45 mm.

Further, for example, mature large seeds and immature small seeds are present in the grapefruit. The immature seeds are present near the core, and the mature large seeds are present in a part slightly distant from the core. In a case of squeezing the fruit juice together with the seeds using the related-art squeezer to make a drink such as a grapefruit sour, the mature large seeds sink, and the immature small seeds float easily. The floating seeds often bring difficulties in drinking the drink. Accordingly, in a case of setting the immature seeds as a main target, the diameter D may be set to 35 mm or less.

Further, the seed removing section 220 separates and squeezes not only the seeds but also the core portion of each segment. Accordingly, the pulp is easily separated, and thus efficient squeezing is possible. In addition, at the time of squeezing, the peel side of the core slightly protrudes, and the protruding portion is positioned above the recess of the seed removing section 220. Accordingly, the protruding portion does not hit against the squeezing section 210 and does not obstruct the squeezing section 210, and hence it is possible to squeeze a fruit without an unnecessary force. Moreover, after the fruit is squeezed completely, an upper portion of the fruit is turned while being shaken, and thus an axis of the core can be removed by the ridge portions 211 protruding at a lip of the opening portion 221.

A plurality of through-holes 224 are formed in the bottom portion 223 of the seed removing section 220 to pass therethrough downward. At least one of a length and a width of each of the through-holes 224 of the seed removing section 220 is smaller than a size of the seeds of the grapefruit, and thus the seed removing section 220 can catch the squeezed seeds of the grapefruit without causing the seeds to fall into the receiving section 240. For example, depending on kinds of grapefruit, the grapefruit may have a large number of immature small seeds, and thus the through-holes 224 are each formed into an elliptical through-hole having, for example, a width within a range of from 1 mm to 2 mm and a length within a range of from 2 mm to 4 mm. With this configuration, the immature seeds are easily caught. Further, even when the fruit juice flows into the seed removing section 220 together with the seeds, the fruit juice that has flowed into the seed removing section 220 flows down into the receiving section 240 through the through-holes 224 of the seed removing section 220, and hence the fruit juice is not accumulated in the seed removing section 220.

The saucer section 230 collects the fruit juice squeezed by the squeezing section 210, and guides the fruit juice into the receiving section 240. The saucer section 230 is formed integrally with the squeezing section 210, and includes a deep bottom portion 231 extending from a lower edge of the squeezing section 210 in the outer peripheral direction and an outer peripheral edge portion 232 extending obliquely upward from an outer peripheral edge of the deep bottom portion 231. The outer peripheral edge portion 232 is placed on a lip portion 245 of the receiving section 240.

A plurality of through-holes 233 are formed in the deep bottom portion 231 to pass therethrough downward. The fruit juice squeezed by the squeezing section 210 flows down into the receiving section 240 through the through-holes 233 of the deep bottom portion 231. The pulp squeezed together with the fruit juice is prevented by the through-holes 233 of the deep bottom portion 231 from falling down into the receiving section 240, and thus the pulp remains on the deep bottom portion 231.

Further, a pulp outlet 234 is formed in the saucer section 230 by extending a part of the outer peripheral edge portion 232 in the outer peripheral direction. The pulp that is obstructed by the through-holes 233 of the deep bottom portion 231 and thus accumulated on the deep bottom portion 231 can be delivered or scooped up for use through the pulp outlet 234.

The receiving section 240 is formed independently of the squeezing section 210, the seed removing section 220, and the saucer section 230, and is constructed as a reservoir for receiving the squeezed fruit juice therein. The receiving section 240 includes a body portion 241, a bottom surface portion 242, a holding portion 243, and a fruit juice outlet 244.

The holding portion 243 is formed at an outer periphery of the body portion 241, and is formed at, for example, an outer periphery of the lip portion 245 serving as an upper edge of the body portion 241. In the holding portion 243, there is formed a finger insertion hole 246 through which a thumb is inserted to hold the holding portion 243. The thumb is inserted through the finger insertion hole 246 to hold the holding portion 243, and thus the receiving section 240 can be retained more stably.

The fruit juice outlet 244 is formed by extending a part of the body portion 241 in the outer peripheral direction. It is preferred that the fruit juice outlet 244 be formed in the outer periphery of the body portion 241 and on a side opposite to the holding portion 243. Under a state in which the saucer section 230 is placed on the receiving section 240, the fruit juice outlet 244 is positioned below the pulp outlet 234 of the saucer section 230, and a clearance is formed between the fruit juice outlet 244 and the pulp outlet 234. The clearance functions as an outflow port, and the fruit juice is poured out through the clearance.

Next, processes of squeezing the fruit juice using the fruit squeezer 200 are described.

Under a state in which the outer peripheral edge portion 232 of the saucer section 230 is placed on the lip portion 245 of the receiving section 240, when one half of the halved grapefruit is placed on the squeezing section 210 with the cut surface of the one half of the halved grapefruit facing down, the opening portion 221 of the seed removing section 220 is brought into abutment on the outer periphery of the seed distribution portion from under the seed distribution portion, and the ridge portions arranged radially around the opening portion 221 of the seed removing section 220 are brought into abutment on the inner sides of the segment membranes. Then, when turning the one half of the halved grapefruit while pressing the grapefruit further downward, the squeezing section 210 increases an abutting area on the one half of the halved grapefruit while biting the one half of the halved grapefruit, to thereby squeeze the fruit juice and the pulp. Although not shown, the outer peripheral edge portion 232 of the saucer section 230 and the lip portion 245 of the receiving section 240 each include a stopper portion which prevents mutual rotation at the time of squeezing.

The fruit juice squeezed by the squeezing section 210 flows down into the receiving section 240 through the through-holes 233 of the saucer section 230 to be accumulated in the receiving section 240. Then, the fruit juice accumulated in the receiving section 240 is poured out through the fruit juice outlet 244 for use. As described above, the fruit juice outlet 244 is positioned below the pulp outlet 234 of the saucer section 230, and the clearance is formed between the fruit juice outlet 244 and the pulp outlet 234. The clearance functions as the outflow port, and the fruit juice is poured out through the clearance.

Further, the pulp squeezed together with the fruit juice is obstructed by the through-holes 233 of the saucer section 230, and thus the pulp remains on the deep bottom portion 231 of the saucer section 230. The pulp can be delivered or scooped up for use through the pulp outlet 234.

Further, the seeds are blocked by the peripheral wall portion 222 of the seed removing section 220 to be collected in the seed removing section 220. Thus, even when the fruit juice flows into the seed removing section 220 together with the seeds, the fruit juice flows down into the receiving section 240 through the through-holes 224 of the seed removing section 220. Accordingly, the fruit juice is accumulated in the receiving section 240, and thus can be poured out for use.

The above-mentioned fruit squeezer 200 according to this embodiment includes the seed removing section 220, and thus can separate the fruit juice, the pulp, and the seeds from one another in a single squeezing operation. Accordingly, the fruit squeezer not only reduces time and labor required for the operation of separating the fruit juice, the pulp, and the seeds from one another, but also requires no use of a utensil and hands, and hence is hygienic.

Further, the through-holes 224 are formed in the seed removing section 220. Accordingly, even when the fruit juice flows into the seed removing section 220 together with the seeds, the fruit juice is allowed to flow into the receiving section 240, and only the seeds can be caught. Further, the ridge portions 211 arranged radially around the opening portion 221 bite the cut surface of one half of the halved grapefruit to tear the segment membranes, and hence the squeezing operation can be performed more quickly.

In addition, the through-holes 233 and the pulp outlet 234 are formed in the saucer section 230. Thus, the pulp squeezed together with the fruit juice can be left on the saucer section 230, and can be delivered or scooped up for use through the pulp outlet 234.

In other words, according to the fruit squeezer 200 of the second embodiment of the present invention, the fruit juice, the pulp, and the seeds can be separated from one another for use. For example, according to the fruit squeezer 200, when drinking alcoholic drinks or non-alcoholic drinks, a desirable amount of the pulp and a desirable amount of the fruit juice can be used depending on individual taste with the single squeezing operation. Further, for example, when cooking in a kitchen, the pulp and the fruit juice can be used in different ways. Specifically, the pulp is used as a topping for salad, and the fruit juice is added to pastry dough.

### Modified Example 1

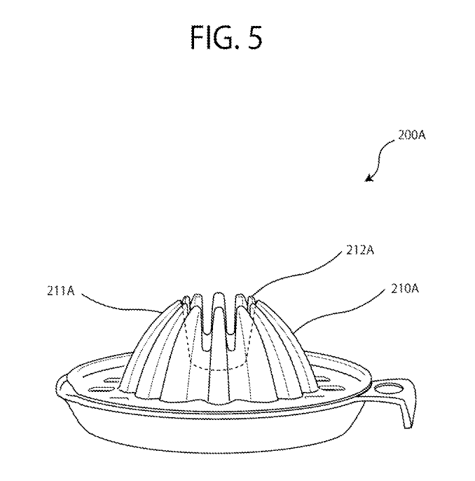

Next, a fruit squeezer 200A according to Modified Example 1 of the second embodiment of the present invention is described. FIG. 5 is a perspective view of the fruit squeezer 200A. In the fruit squeezer 200A, only a squeezing section 210A is different from the components of the second embodiment. Accordingly, in the following description, the same components as those of the second embodiment are denoted by the same reference symbols, and description thereof is omitted. Different points are described below.

The squeezing section 210A is brought into abutment on the cut surface of one half of the halved grapefruit so as to squeeze the fruit juice and the pulp. The squeezing section 210A has a substantially conical shape projecting upward, and includes a plurality of ridge portions 211A that are formed on an outer peripheral surface of the squeezing section 210A to project in a radially outer direction. A groove is formed between the adjacent ridge portions.

The ridge portions 211A of the squeezing section 210A are extended upward in vicinities of distal ends thereof to form claw-like protrusions 212A. When pressing the cut surface of one half of the halved grapefruit against the squeezing section 210A to squeeze the fruit juice and the pulp, the claw-like protrusions 212A tear the segment membranes, and hence the fruit juice and the pulp can be squeezed more efficiently.

As described above, according to the fruit squeezer 200A of Modified Example 1 of the second embodiment of the present invention, it is not only possible to separate the fruit juice, the pulp, and the seeds from one another for use, but also possible to perform the squeezing operation more quickly because the claw-like protrusions 212A tear the segment membranes.

Note that, the claw-like protrusions 212A may be formed on an entire surface of the squeezing section 210A. However, when the protruding portions apply strong resistance to a large fruit such as a grapefruit, the fruit is easily crushed, and thus is difficult to turn and squeeze. Accordingly, the conical squeezing section supports an entire shape of the fruit, and the claw-like protrusions gradually tear the segment membranes to squeeze the fruit in such a manner that the fruit is not crushed.

### Modified Example 2

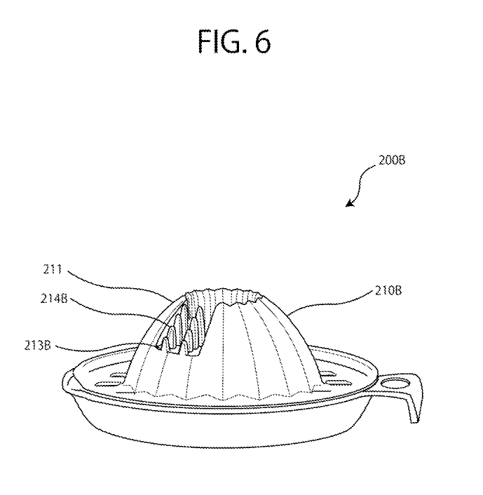

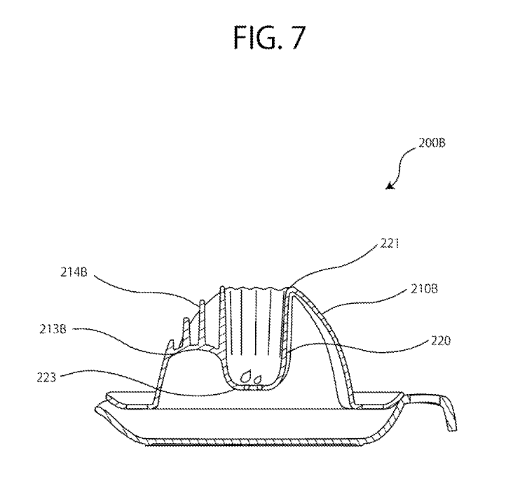

Next, a fruit squeezer 200B according to Modified Example 2 of the second embodiment of the present invention is described. FIG. 6 is a perspective view of the fruit squeezer 200B, and FIG. 7 is a side cross-sectional view of the fruit squeezer 200B. In the fruit squeezer 200B, only a squeezing section 210B is different from the components of the second embodiment. Accordingly, in the following description, the same components as those of the second embodiment are denoted by the same reference symbols, and description thereof is omitted. Different points are described below.

The squeezing section 210B is brought into abutment on the cut surface of one half of the halved grapefruit so as to squeeze the fruit juice contained in the pulp of the grapefruit. The squeezing section 210B has a substantially conical shape projecting upward, and includes the plurality of ridge portions 211 that are formed on an outer peripheral surface of the squeezing section 210B to project in a radially outer direction. A groove is formed between the adjacent ridge portions.

In the squeezing section 210B, at a position above the bottom portion 223 of the seed removing section 220 and below the opening portion 221, a part of the ridge portions 211 is formed into a base surface 213B exhibiting a substantially flat surface, and spine-like (skewer-like) protrusions 214B are formed on the base surface 213B. When pressing the cut surface of one half of the halved grapefruit against the squeezing section 210B to squeeze the fruit juice and the pulp, the spine-like protrusions 214B cut the segment membranes, and hence the fruit juice can be squeezed efficiently.

As described above, according to the fruit squeezer 200B of Modified Example 2 of the second embodiment of the present invention, it is not only possible to separate the fruit juice, the pulp, and the seeds from one another for use, but also possible to perform the squeezing operation more quickly because the spine-like protrusions 214B are formed in the squeezing section 210B and thus the spine-like protrusions 214B cut the segment membranes.

### Modified Example 3

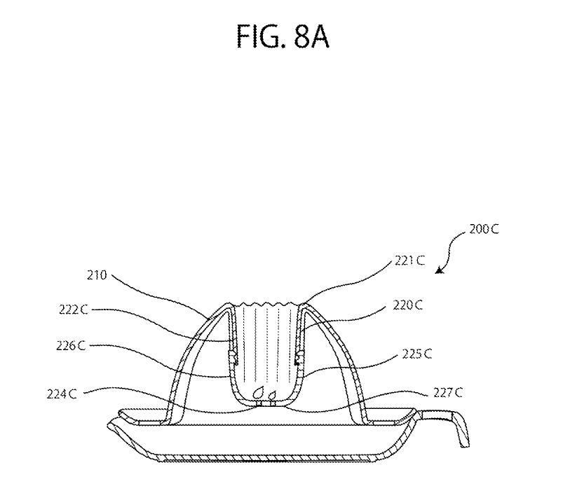

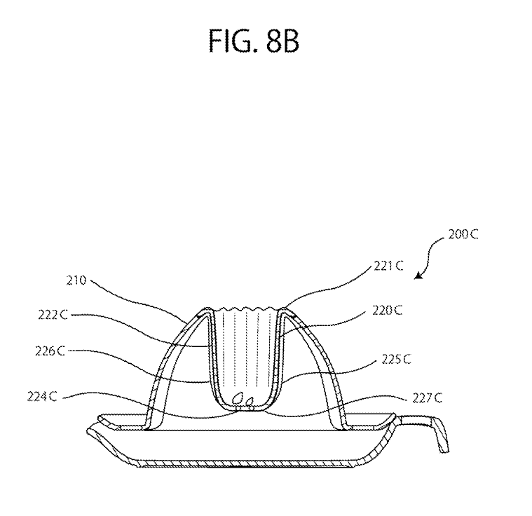

Next, a fruit squeezer 200C according to Modified Example 3 of the second embodiment of the present invention is described. FIG. 8 are side cross-sectional views of the fruit squeezer 200C. FIG. 8A is a side cross-sectional view of an example of the fruit squeezer 200C, and FIG. 8B is a side cross-sectional view of another example of the fruit squeezer 200C. In the fruit squeezer 200C, only a seed removing section 220C is different from the components of the second embodiment. Accordingly, in the following description, the same components as those of the second embodiment are denoted by the same reference symbols, and description thereof is omitted. Different points are described below.

The seed removing section 220C is formed into a recessed portion in a center portion of the squeezing section 210, and is configured to catch the seeds squeezed out of the fruit by the squeezing section 210. The seed removing section 220C includes an opening portion 221C, a peripheral wall portion 222C, and a seed removing tool 225C.

In the seed removing section 220C, instead of the bottom portion, the seed removing tool 225C is detachably fixed to a lower end of the peripheral wall portion 222C. The seed removing tool 225C includes a cylindrical portion 226C having a tubular shape and a seed removing surface 227C that closes a lower end of the cylindrical portion 226C, and a plurality of through-holes 224C are formed in the seed removing surface 227C. Note that, the seed removing tool 225C is retained in such a manner that a protrusion formed on a periphery of an inner wall of the cylindrical portion 226C of the seed removing tool 225C is fitted into a groove formed in a periphery of the peripheral wall portion 222C. Alternatively, the seed removing tool 225C may be retained in a contrary manner, or each of the seed removing tool 225C and the peripheral wall portion 222C may include a male screw or a female screw so that the seed removing tool 225C is retained with screw structure.

The through-holes 224C of the seed removing section 220C are each formed into, for example, a circular hole having a diameter of from 1 mm to 2 mm or an elliptical through-hole having a width within a range of from 1 mm to 2 mm and a length within a range of from 2 mm to 4 mm. With this configuration, even when the fruit juice flows into the seed removing section 220C together with the seeds, the fruit juice that has flowed into the seed removing section 220C flows down into the receiving section 240 through the through-holes 224C, and hence the fruit juice is not accumulated in the seed removing section 220C.

As described above, according to the fruit squeezer 200C of Modified Example 3 of the second embodiment of the present invention, the seed removing tool 225C is detachable, and hence at the time of squeezing the fruit, only the seed removing tool 225C is detached to remove the accumulated seeds, and then washed and attached again. Thus, it is possible to squeeze the fruit continuously, and hence convenience is increased. Further, after use, the seed removing tool 225C can be detached and washed, and hence it is also convenient to wash the through-holes that may be easily soiled.

Further, although not shown, the fruit squeezer 200C may have a plurality of through-holes formed in the seed removing tool 225C to extend in a direction substantially perpendicular to an inner peripheral surface of the cylindrical portion 226C. With this configuration, the fruit juice that has flowed into the seed removing section 220C flows down into the receiving section 240 further easily.

In addition, as illustrated in FIG. 8B, the seed removing tool 225C may include the peripheral wall portion 222C and the opening portion 221C, and may be structured to be placed and fitted on the squeezing section 210C from above. In this case, as a configuration for preventing the seed removing tool 225C and the squeezing section 210 from slipping laterally at the time of squeezing under a state in which the seed removing tool 225C is placed on the squeezing section 210C, there is adopted such a configuration that in an abutting surface therebetween, a protruding portion is formed on the seed removing tool 225C, whereas a recessed portion is formed in a body of the squeezing section 210, thereby fitting the seed removing tool 225C and the squeezing section 210 on each other. Alternatively, the seed removing tool 225C and the squeezing section 210 may be fitted on each other in a contrary manner, or other configuration having the same effect may be adopted.

### Modified Example 4

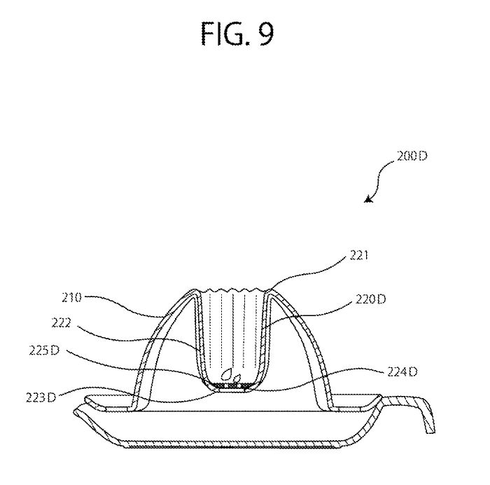

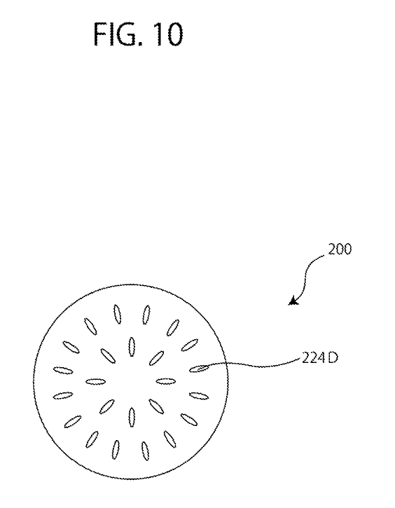

Next, a fruit squeezer 200D according to Modified Example 4 of the second embodiment of the present invention is described. FIG. 9 is a side cross-sectional view of the fruit squeezer 200D, and FIG. 10 is a top plan view of an example of a seed removing tool 225D. In the fruit squeezer 200D, only a seed removing section 220D is different from the components of the second embodiment. Accordingly, in the following description, the same components as those of the second embodiment are denoted by the same reference symbols, and description thereof is omitted. Different points are described below.

The seed removing section 220D is formed into a recessed portion in a center portion of the squeezing section 210, and is configured to catch the seeds squeezed out of the fruit by the squeezing section 210. The seed removing section 220D includes the opening portion 221, the peripheral wall portion 222, a bottom portion 223D, and a seed removing tool 225D.

An opening is formed in a center portion of the bottom portion 223D of the seed removing section 220D. The seed removing tool 225D has a circular plate-like shape with a diameter larger than a diameter of the opening of the center portion of the bottom portion 223D, and the seed removing tool 225D is placed on the bottom portion 223D. That is, the seed removing tool 225D is placed so as to close the opening of the center portion of the bottom portion 223D from above.

A plurality of through-holes 224D are formed in the seed removing tool 225D. Even when the seed removing tool 225D is placed in the seed removing section 220D at the time of squeezing the fruit and the fruit juice flows into the seed removing section 220D together with the seeds, the fruit juice that has flowed into the seed removing section 220D flows down into the receiving section 240 through the through-holes 224D of the seed removing tool 225D, and hence the fruit juice is not accumulated in the seed removing section 220D.

As described above, according to the fruit squeezer 200D of Modified Example 4 of the second embodiment of the present invention, only the seed removing tool 225D can be detached, and hence convenience is further increased. For example, after use, the seed removing tool 225D can be taken out and washed, and hence it is also convenient to wash the through-holes that may be easily soiled.

Further, the fruit squeezer 200D according to Modified Example 4 of the second embodiment of the present invention may include a plurality of seed removing tools 225D. For example, the plurality of seed removing tools 225D differ in shapes and sizes of the through-holes 224D, and the seed removing tools 225D can be appropriately selected and used depending on a fruit to be squeezed. Further, the plurality of seed removing tools 225D may have the same shape, and the soiled seed removing tool 225D may be replaced with another seed removing tool 225D.

Note that, in the above description, the through-holes 224, the through-holes 224C, and the through-holes 224D have substantially elongated elliptical shapes, but the present invention is not limited thereto. For example, other shapes such as a circular shape and a rectangular shape may be adopted, or combination of elongated elliptical, circular, and rectangular shapes may be adopted.

### Third Embodiment

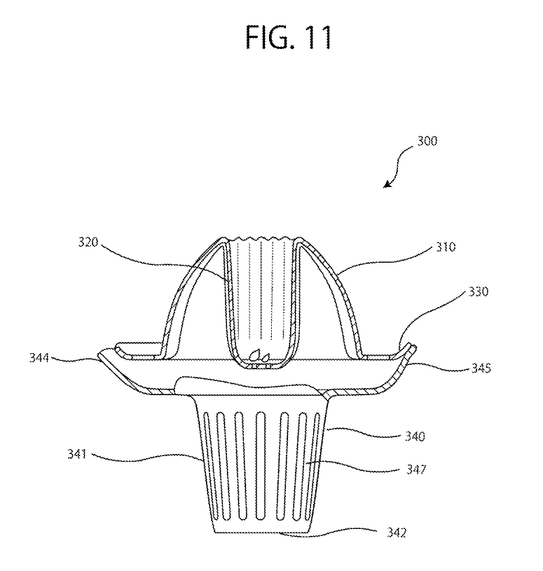

Next, a fruit squeezer 300 according to a third embodiment of the present invention is described. FIG. 11 is a side cross-sectional view of the fruit squeezer 300. As illustrated in FIG. 11, the fruit squeezer 300 includes a squeezing section 310, a seed removing section 320, a saucer section 330, and a receiving section 340. The squeezing section 310, the seed removing section 320, and the saucer section 330 respectively have features common to the squeezing section 210, the seed removing section 220, and the saucer section 230 of the fruit squeezer 200 according to the second embodiment, and hence description thereof is omitted below.

The receiving section 340 is formed independently of the squeezing section 310 and the saucer section 330, and includes a body portion 341, a bottom surface portion 342, and a fruit juice outlet 344. The receiving section 340 is a reservoir for receiving the squeezed fruit juice therein. The fruit juice outlet 344 is formed by extending in the outer peripheral direction a part of a lip portion 345 serving as an upper end of the receiving section 340.

The body portion 341 is formed into a hollow tubular body having a size large enough to be grasped naturally by one hand, for example, having a diameter of from 60 mm to 80 mm. The lip portion 345 serving as the upper end of the body portion 341 has a substantially dish-like shape extending in the outer peripheral direction, and the saucer section 330 is placed on the lip portion 345. When the squeezing section 310 squeezes the fruit juice, the body portion 341 functions as a portion to be grasped. With this configuration, when squeezing the fruit juice, the operation is performed while the body portion of the receiving section is grasped by five fingers and an entire palm of the hand, and hence it is possible to squeeze the fruit juice under a state in which the fruit squeezer is grasped with a satisfactory force.

The bottom surface portion 342 closes a lower end of the body portion 341. It is preferred that the body portion 341 be formed so as to be gradually narrowed toward the bottom surface portion 342. With this configuration, the body portion 341 has a shape approximate to a shape that allows a form of the hand obtained when a first is clenched, and hence the receiving section 340 is easily grasped.

A nonslip portion 347 is formed on an outer peripheral surface of the body portion 341. The nonslip portion 347 increases a frictional force when the body portion 341 is grasped, to thereby enable the fruit squeezer 300 to be more stably retained. It is preferred that the nonslip portion 347 have gentle rise and fall formed of a plurality of shallow grooves extending longitudinally in the outer peripheral surface of the body portion 341. With this configuration, the fruit squeezer 300 has simple structure, and is also excellent in washing and drying.

As described above, according to the fruit squeezer 300 of the third embodiment of the present invention, it is not only possible to separate the fruit juice, the pulp, and the seeds from one another for use, but also possible to firmly grasp the fruit squeezer by one hand at a position below a position of performing the squeezing operation because the fruit squeezer 300 includes the body portion 341 that is formed into a tubular body and functions as the portion to be grasped including the nonslip portion formed on the outer peripheral surface thereof. Accordingly, even when there is no flat table on which the fruit squeezer is to be placed, the squeezing operation can be performed stably with a satisfactory force.

Note that, although not shown, the fruit squeezer 300 according to the third embodiment of the present invention may further include a grip that is formed on a side wall of the receiving section 340 on a side opposite to the fruit juice outlet 344. The grip is formed, and thus when the fruit juice is poured out of the receiving section 340, the fruit squeezer 300 can be lifted and moved stably with a satisfactory force to pour the fruit juice out of the receiving section 340.

### Modified Example 1

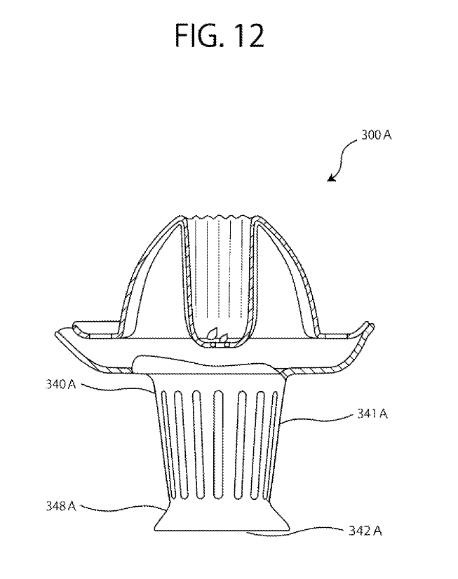

Next, a fruit squeezer 300A according to Modified Example 1 of the third embodiment of the present invention is described. FIG. 12 is a side cross-sectional view of the fruit squeezer 300A. In the fruit squeezer 300A, only a receiving section 340A is different from the components of the third embodiment. Accordingly, in the following description, the same components as those of the third embodiment are denoted by the same reference symbols, and description thereof is omitted. Different points are described below.

The receiving section 340A includes a pedestal portion 348A extending in an umbrella manner from a lower end of a body portion 341A toward a bottom surface portion 342A in the outer peripheral direction.

The fruit squeezer 300A according to Modified Example 1 of the third embodiment of the present invention further includes the pedestal portion 348A, and hence increases a contact surface with an operation surface, to thereby enhance stability.

In this case, the pedestal portion 348A may be formed integrally with the body portion 341A. Alternatively, the pedestal portion 348A may be formed separately from the body portion 341A to be assembled afterward. Further, a shaft is provided to the receiving section 340A, and the pedestal portion 348A may be rotatably mounted to the shaft.

Note that, each component of each of the above-mentioned fruit squeezers according to the present invention may be made of a plastic resin. Further, each component may be formed of, for example, a pressed thin sheet of stainless steel, or may be formed of a combination of a plastic resin and a pressed thin sheet of stainless steel.

Further, in order to prevent a main body of the fruit squeezer from easily moving and to perform squeezing easily, a nonslip portion made of silicon rubber or elastomer may be arranged on an outer side of the bottom surface portion of the receiving section.

The fruit squeezers according to the embodiments of the present invention are described above. However, each of the above-mentioned fruit squeezers is merely an example of the embodiments of the present invention, and the present invention is not limited thereto. For example, the present invention encompasses various modified examples and modes obtained through combination of the above-mentioned embodiments. For example, the fruit squeezer according to the first embodiment may include an outlet, and may include a holding portion. Further, the fruit squeezer according to each embodiment may include a lid.

### REFERENCE SIGNS LIST

100, 200, 200A, 200B, 200C, 200D, 300, 300A fruit squeezer
110, 210, 210A, 210B, 310 squeezing section
111, 211, 211A ridge portion
212A claw-like protrusion
213B base surface
114, 214B spine-like protrusion
120, 220, 220C, 220D, 320 seed removing section
121, 221, 221C opening portion
122, 222, 222C peripheral wall portion
123, 223, 223D bottom portion
224, 224C, 224D through-hole
225C, 225D seed removing tool
226C cylindrical portion
227C seed removing surface
230, 330 saucer section
231 deep bottom portion
232 outer peripheral edge portion
233 through-hole
234 pulp outlet
140, 240, 340, 340A receiving section
241, 341, 341A body portion
242, 342, 342A bottom surface portion
243 holding portion
244, 344 fruit juice outlet
245, 345 lip portion
246 finger insertion hole
347 nonslip portion
348A pedestal portion

1. A fruit squeezer, comprising:
a squeezing section configured such that a fruit is to be pressed thereagainst;
a saucer section;
a receiving section configured to receive therein fruit juice squeezed by the squeezing section; and
a seed removing section formed into a recessed portion in a center portion of the squeezing section, and configured to catch seeds,
the seed removing section comprising:
an opening portion;
a bottom portion;
a peripheral wall portion having a tubular shape and connecting the opening portion and the bottom portion to each other; and
a plurality of through-holes formed in the bottom portion or the peripheral wall portion or both of the bottom portion and the peripheral wall portion,
wherein the squeezing section has a substantially conical shape projecting upward, the squeezing section comprising a plurality of ridge portions formed on an outer peripheral surface of the squeezing section so as to project in a radially outer direction,
wherein the saucer section formed integrally with the
squeezing section so as to extend from a lower edge of the squeezing section in the outer peripheral direction and further extend obliquely upward, the saucer section having at least a plurality of through-holes they allow the fruit juice to flow down therethrough,
wherein the receiving section is formed independently of the squeezing section, and functions as a reservoir comprising at least a body portion and a bottom surface portion,
wherein the seed removing section has a depth larger than a diameter thereof.

2-3. (canceled)

4. A fruit squeezer according to claim 1,
wherein the bottom portion of the seed removing section is detachably fixed to a lower end of the peripheral wall portion of the seed removing section, and is formed of a seed removing tool comprising a cylindrical portion having a tubular shape and a seed removing surface that closes a lower end of the cylindrical portion, and
wherein the plurality of through-holes of the seed removing section are formed in the seed removing surface of the seed removing tool.

5. A fruit squeezer according to claim 1,
wherein the seed removing section comprises one or a plurality of plate-like seed removing tools,
wherein the bottom portion of the seed removing section has an opening formed in a center portion thereof,
wherein each of the one or the plurality of plate-like seed removing tools is placed on the bottom portion of the seed removing section in use so as to close the opening, and
wherein the plurality of through-holes of the seed removing section are formed in the each of the one or the plurality of plate-like seed removing tools.

6. A fruit squeezer according to claim 1, wherein the plurality of through-holes of the seed removing section each comprise a substantially elongated elliptical through-hole having a width within a range of from 1 mm to 2 mm and a length within a range of from 2 mm to 4 mm.

7. A fruit squeezer according to claim 1,
wherein a part of the plurality of ridge portions of the squeezing section is formed into a substantially flat surface at a position above the bottom portion of the seed removing section and below the opening portion of the seed removing section, and
wherein the substantially flat surface has a spine-like protrusion formed thereon.

8. A fruit squeezer according to claim 1,
wherein the body portion of the receiving section comprises a hollow tubular body having a diameter within a range of from 60 mm to 80 mm, and
wherein the receiving section comprises a lip portion serving as an upper end of the body portion thereof, the lip portion having a substantially dish-like shape extending in the outer peripheral direction.

9. A fruit squeezer according to claim 8,
wherein the body portion of the receiving section comprises a nonslip portion formed of a plurality of shallow grooves extending longitudinally in an outer peripheral surface of the body portion.

10. A fruit squeezer according to claim 8,
wherein the receiving section comprises a pedestal portion extending in an umbrella manner from a lower end of the body portion toward the bottom surface portion in the outer peripheral direction.
